(19) United States
(12) Patent Application Publication
(10) Pub. No.: US 2025/0235051 A1
(43) Pub. Date: Jul. 24, 2025

(54) FOOD DISPENSER

(71) Applicant: Kernel Foods, Inc., New York, NY (US)

(72) Inventor: John Lawrence GOERS, Centennial, CO (US)

(21) Appl. No.: 19/035,521

(22) Filed: Jan. 23, 2025

Related U.S. Application Data
(60) Provisional application No. 63/624,212, filed on Jan. 23, 2024.

(51) Int. Cl. A47J 47/01; B65G 65/46

(52) U.S. Cl. CPC A47J 47/01; B65G 65/46

(57) ABSTRACT

Some embodiments described herein relate to a container and an augur. The container can include a first protrusion and a second protrusion, each defining an opening. The auger can be configured to rotate within the first protrusion and the second protrusion to expel materials from the container. The augur can be configured to be removably coupled to a motor such that the augur and the container can be collectively removed from the motor. In some embodiments caps can be removably coupled to the first opening and/or the second opening such that the container can be sealed, for example, for storage or transport. Similarly, a lid can be configured to be releasably coupled to a top opening to seal the container.

### CROSS REFERENCE TO RELATED APPLICATIONS

The present application claims priority to and benefit of provisional U.S. Patent Application No. 63/624,212, filed on Jan. 23, 2024 “Food Dispenser” which is incorporated by reference herein.

### BACKGROUND

Cooking has long been a labor-intensive activity, and therefore there has been a long history of efforts to increase automation and reduce manual activity. For example, there are known food dispensers configured to automatically dispense food from a hopper. Such known food dispensers, however, typically include hoppers that cannot be removed, sealed, transported, and/or used to prevent food spoilage.

A need therefore exists for food dispensers that include a hopper amenable to dispensation and safe transport of food.

### BRIEF DESCRIPTION OF THE DRAWINGS

FIGS. 1A and 1B depict a perspective view and a side view cross-section, respectively, of a dispenser, according to an embodiment.

FIGS. 2A-2C depict, respectively, a first perspective view, a second perspective view, and a side cross section view, of a hopper and an auger 120, according to an embodiment.

FIG. 2D depicts a side view of the hopper of FIGS. 2A-2C, caps, and a lid, according to an embodiment.

FIGS. 2E-2F depict, respectively, a perspective view of the lid and a perspective view of a cap of FIG. 2D.

FIGS. 3A-3B depict, respectively, a perspective view and a perspective cutaway view, of a base, according to an embodiment.

### DETAILED DESCRIPTION

Some embodiments described herein relate to a container and an augur. The container can include a first protrusion and a second protrusion, each defining an opening. The auger can be configured to rotate within the first protrusion and the second protrusion to expel materials from the container. The augur can be configured to be removably coupled to a motor such that the augur and the container can be collectively removed from the motor. In some embodiments caps can be removably coupled to the first opening and/or the second opening such that the container can be sealed, for example, for storage or transport. Similarly, a lid can be configured to be releasably coupled to a top opening to seal the container.

Some embodiments described herein relate to a method that includes filling, at a first location, a first container with food material via an upper opening. The first container can include a first protrusion that defines an outlet and a second protrusion that defines an interface opening. An auger can be disposed within the first protrusion and the second protrusion. A lid can be coupled to the upper opening, and the container can be stored and moved within a transport container to a second location. Caps that are removably coupled to the outlet and the interface opening can be removed, and the auger can be coupled to a motor via the interface opening. The motor can be activated to cause the auger to rotate and food material to be dispensed via the outlet.

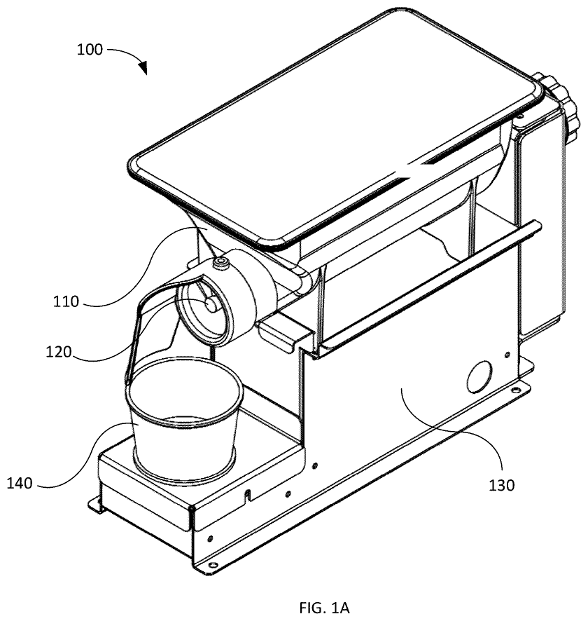

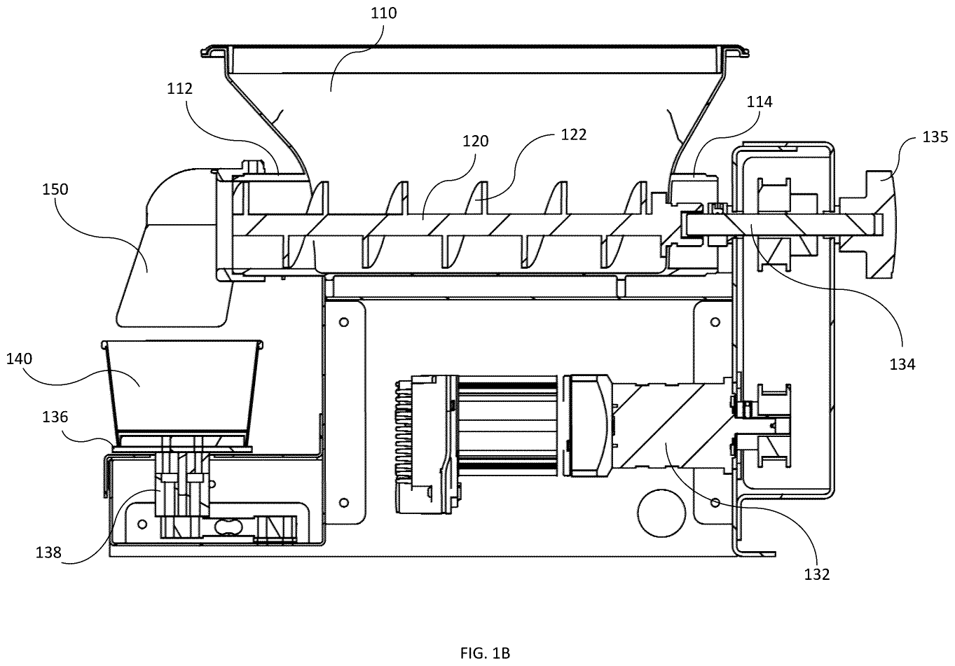

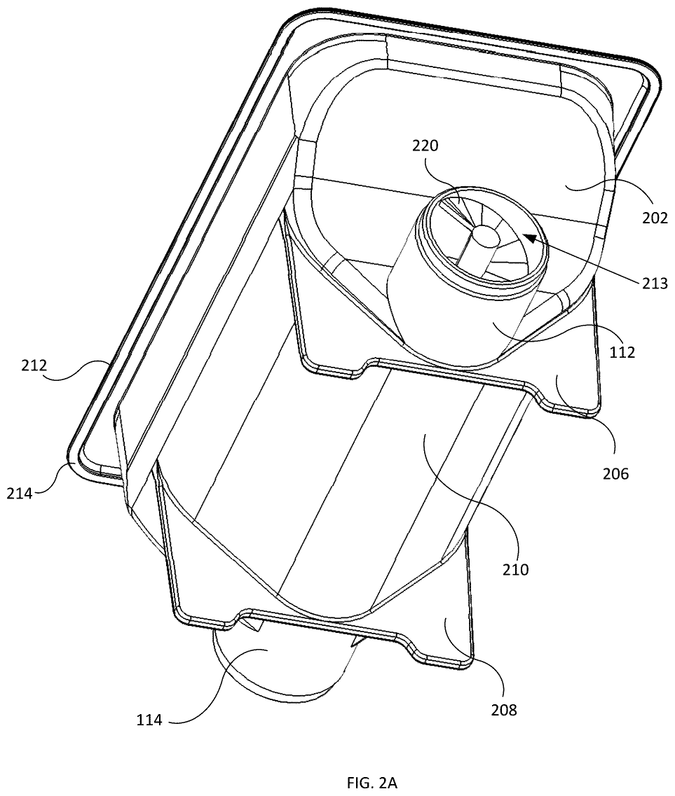

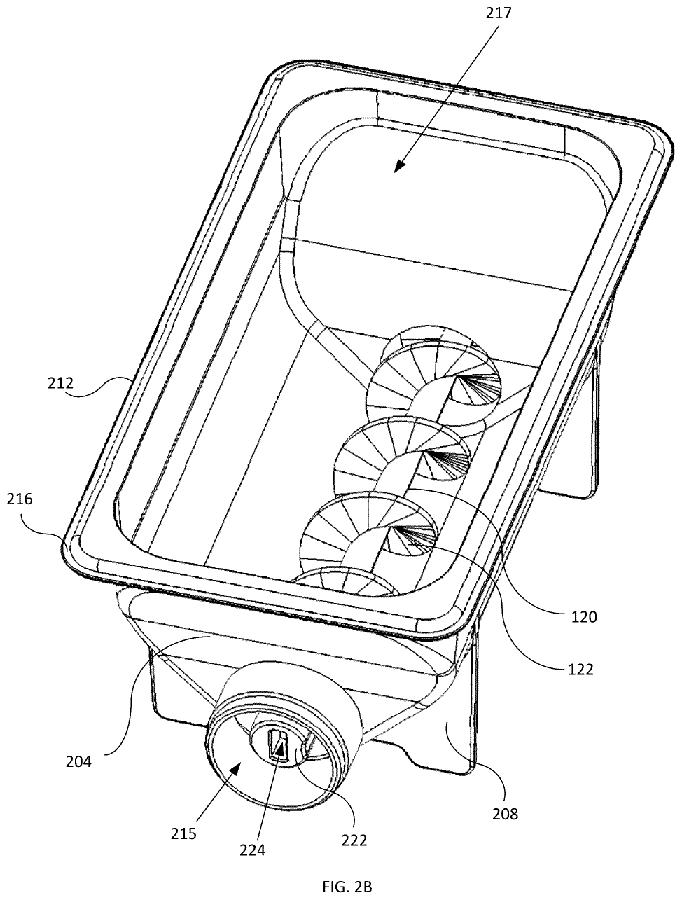

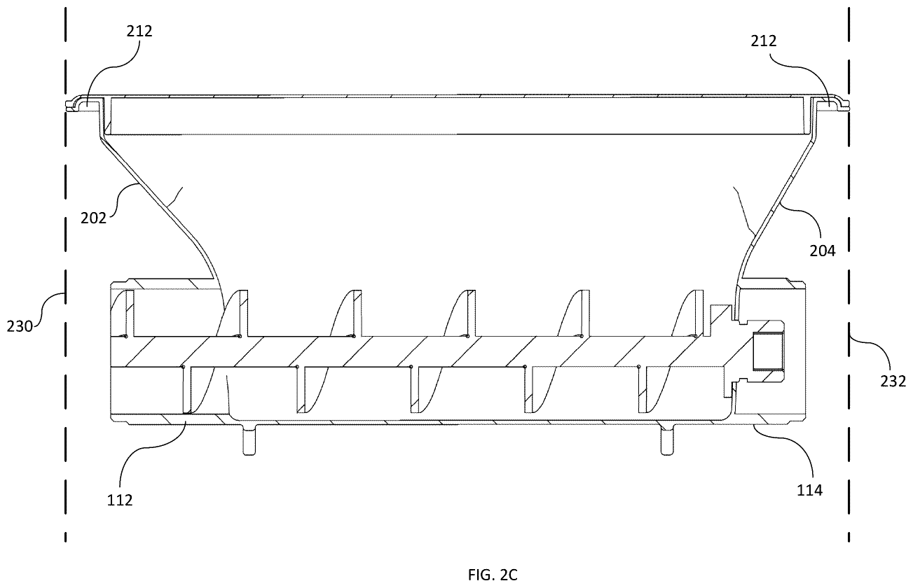

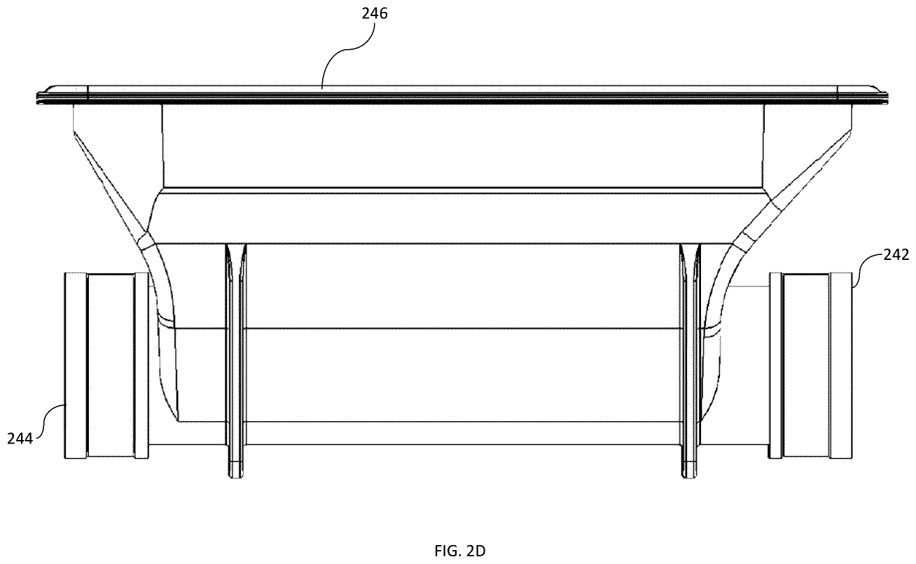

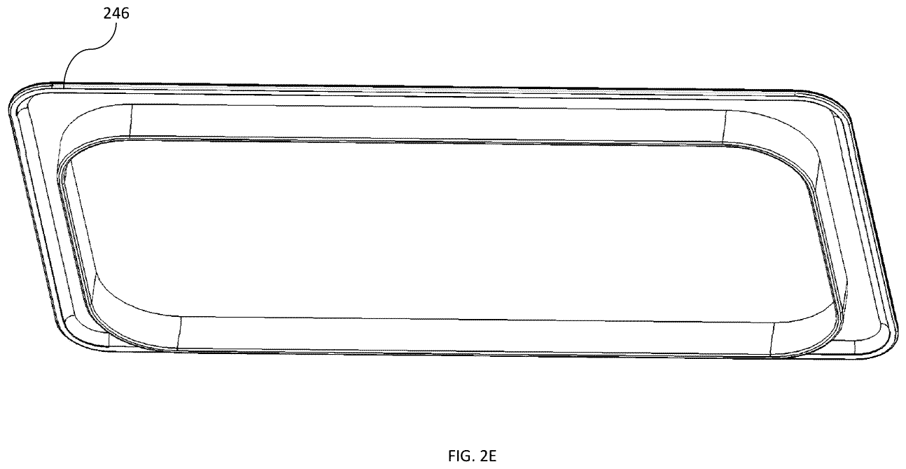

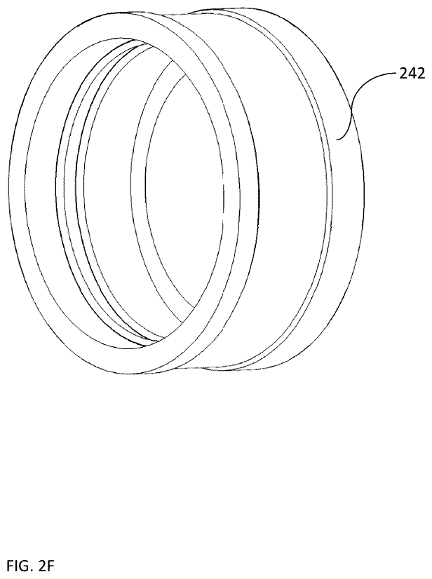

FIGS. 1A and 1B depict a perspective view and a side view cross-section, respectively, of a dispenser 100. The dispenser 100 can include a hopper 110 (e.g., container) that can be releasably coupled to a base 130. The base 130 can include a motor 132 that can be activated to cause an auger 120 disposed within the hopper 110 to rotate, in turn causing contents (e.g., food material) to be dispensed from the hopper 110 into a food vessel 140 (e.g., a serving vessel, such as a reusable serving bowl or a disposable serving bowl) and/or any suitable receptacle. While uncoupled from the base 130, the hopper 110 can be configured to hold contents (e.g., food material) within an interior volume of the hopper 110 and/or prevent contained contents from escaping (e.g., by covering an opening(s) of the hopper 110 with a lid 246 (s), shown in FIG. 2D, and/or a cap(s), as described herein). The hopper 110 can also be configured to be disposed (e.g., stored, secured, etc.) within a transport bag, carrier, etc. Specifically, in some implementations, the hopper 110 can include a lip 212 (e.g., the lip 212 of FIG. 2A, as described herein) configured to interface with a food pan carrier, such that the hopper 110 can be suspended, held, etc., within the food pan carrier, as described herein.

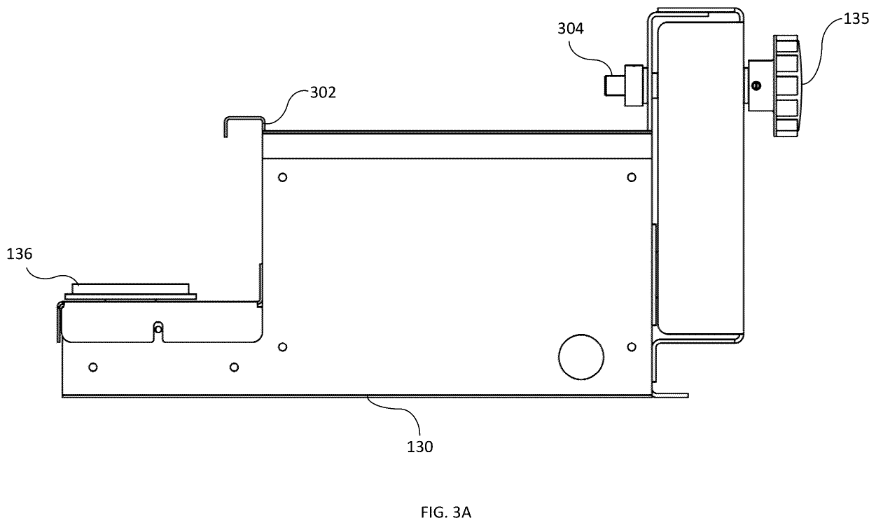

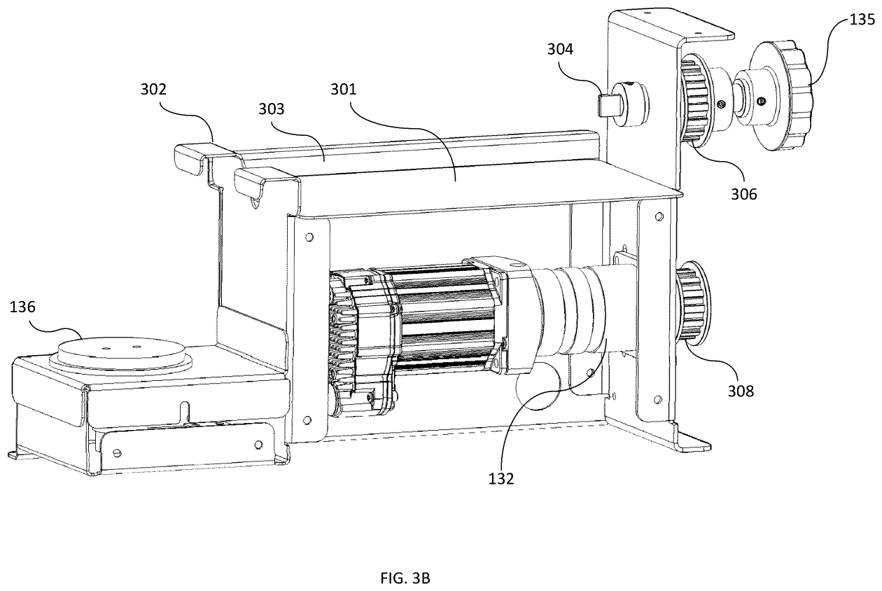

As described herein at least in relation to FIG. 2B, a first end portion of the auger 120 can be disposed within at least a portion of a first protrusion 112 of the hopper 110 and a second end portion of the auger 120 can be disposed within a second protrusion 114 of the hopper 110. The auger 120 can include at least one winding 122. As described herein at least in relation to FIGS. 3A-3B, the base 130 can include the motor 132, an output shaft 134, a dial 135, a weighing surface 136, a load cell 138, and a guide 150.

FIGS. 2A-2C depict, respectively, a first perspective view, a second perspective view, and a side cross section view, of the hopper 110 and the auger 120. FIG. 2D depicts a side view of the hopper 110, caps 242 and 244, and a lid 246. FIGS. 2E-2F depict, respectively, a perspective view of the lid 246 and a perspective view of a cap 242.

The hopper 110 can define a volume in which contents (e.g., food materials, such as raw and/or cooked vegetables, nuts, seeds, croutons, cheese, and/or the like) can be disposed. Alternatively or in addition, the contents can include, for example, hot food materials (e.g., grilled vegetables and/or the like), cold food materials, dry food materials, wet food materials, a combination and/or composition of two or more different food materials (e.g., cucumbers and rice concurrently disposed within the hopper 110), and/or the like. The hopper 110 can include a foundation configured to support the hopper 110 in an upright orientation relative to a support surface (e.g., a table, counter, base support surface (described herein), etc.). In some implementations, the foundation can include at least two stands (e.g., stands 206 and 208) disposed between a lower portion of the hopper 110 and the support surface. For example, the lower portion of the hopper 110 can define a trough 210, and each stand (e.g., stands 206 and 208) from the at least two stands can straddle the trough 210 at a first edge of each respective stand from the at least two stands. A second edge, substantially opposite the first edge, of each respective stand can be planar relative to the remaining edge(s) from the at least two stands, such that the at least two stands can support the hopper 110 on the support surface. In some implementations, the foundation can define at least a portion of an at least substantially quadrilateral perimeter. The hopper 110 can also include at least one sidewall (e.g., four sidewalls) extending upward, relative to the support surface, from the trough 210. The at least one sidewall can define an upper opening 217 in fluid communication with the volume and through which the contents can enter the hopper 110 as the hopper 110 is being filled.

The hopper 110 can include a first protrusion 112 and a second protrusion 114, each of which can be disposed at the at least one sidewall (e.g., respectively, at the first sidewall 202 and the second sidewall 204). In some implementations, as shown in FIGS. 2A-2E, the at least one sidewall can include four sidewalls, and the first protrusion 112 can be disposed at the first sidewall 202 from the four sidewalls, and the second protrusion 114 can be disposed at a second sidewall 204 (1) from the four sidewalls and (2) opposite the first sidewall 202. The first protrusion 112 and the second protrusion 114 can be centered or substantially centered relative to an axis that equally divides the foundation (e.g., the stands 206-208) and intersects with the first sidewall 202 and the second sidewall 204. For example, the axis can be aligned over and along the trough 210 of the hopper 110, such that the first protrusion 112, the second protrusion 114, and the trough 110 are substantially aligned along the axis. The first protrusion 112 and the second protrusion 114 can also be centered (or substantially centered) relative to a horizontal plane, such that the first protrusion 112 and the second protrusion 114 can be at least substantially aligned horizontally relative to each other. For example, the first protrusion 112 and the second protrusion 114 can be substantially equidistant relative to (1) the base and/or (2) the support surface while the hopper 110 rests on the support surface. The first protrusion 112 and the second protrusion 114 can extend outwardly relative to the at least one sidewall and/or at least a substantial portion of the volume defined by the hopper 110. The first protrusion 112 and the second protrusion 114 can each define a channel in fluid communication with the volume defined by the hopper 110. For example, in some implementations, the first protrusion 112 and the second protrusion 114 can each include a cylindrical tube having (1) a first edge coupled to, respectively, the first sidewall and the second sidewall and (2) a second edge substantially opposite the first edge and defining a circular opening (e.g., respectively, a first opening 213 and a second opening 215). In some implementations, the first protrusion 112, the second protrusion 114, and the trough 110 can each define a radius, and each of these raii can have, relative to each other, substantially similar lengths from a common axis (e.g., an axis disposed within the openings defined by the first protrusion 112 and the second protrusion 114).

An auger 120 (e.g., a radial screw and/or the like) can be disposed between the circular openings defined by the first protrusion 112 and the second protrusion 114. For example, a first end portion of the auger can be disposed within a portion of the channel defined by the first protrusion 112, and a second end portion of the auger can be disposed within a portion of the channel defined by the second protrusion 114. The second end portion of the auger can include a motor drive interface 222 that can define a depression 224 and can be configured to releasably couple to a motor (e.g., via an output shaft), as described herein. The auger 120 can include a helical thread that includes a plurality of windings and/or flutes (e.g., including the winding 122). The plurality of windings can be spaced such that they can at least partially enclose food material (e.g., chopped vegetables, croutons, cheese, and/or the like) between a pair of windings and the trough 110 and/or cause the food material to be moved towards the outlet defined by the first protrusion 112 while the motor 132 rotates the auger 120, as described herein. In some implementations, an auger 120 can be selected from a plurality of augers, where each auger can have a different pitch, diameter, and/or type. The auger 120 can be selected from the plurality of augers based the type of food material to be dispensed from the hopper 110. For example, foods with larger chunks may require larger pitches and/or diameters to prevent food from “bridging” between two or more windings. Foods with nuts or other hard contents may require augers that do not create a shear point between the auger and the housing at the discharge (i.e. wire formed augers or other similar constructions). The auger 120 can be selectively coupled to the hopper 110 such that it can be removed for cleaning.

The hopper 110 can further include a lip 212 disposed at or proximal to an upper edge(s), substantially opposite the foundation (e.g., the stands 206 and 208), of the at least one sidewall (e.g., the sidewalls 202 and 204). The lip 212 can include a surface (1) that is at least substantially parallel to the support surface while the hopper 110 rests on the support surface and/or (2) that defines a plane different from a plane defined by the at least one sidewall (e.g., the sidewalls 202 and 204). The lip 212 can circumscribe the upper opening 217 defined by the hopper 110. In some implementations, the at least one sidewall can include four sidewalls, and the lip 212 can define an at least substantially quadrilateral perimeter. The lip 212 can overhang the at least one sidewall, extending proud relative to a vertical plane (e.g., the vertical plane 230 and/or the vertical plane 232, depicted in FIG. 2C) that is substantially perpendicular to the support surface while the hopper 110 rests on the support surface and that intersects the at least one sidewall, the first protrusion 112, and/or the second protrusion 114. Similarly stated, a perimeter defined by the lip 212 can define an area that is larger than the area of a perimeter defined by the at least one sidewall and/or the area of perimeter partially defined by the first protrusion 112 and/or the second protrusion 114. In some implementations, at least the first side wall 202 and the second sidewall 204, from the four sidewalls, can have a tapered profile, such that the first protrusion 112 and the second protrusion 114 are disposed inwardly relative to a perimeter defined by the lip 212.

The lip 212 can be dimensioned to interface with a carrier (e.g., a Cambro® carrier), container, bag, etc., for storage and/or transport. For example, as a result of the first protrusion 112 and the second protrusion 114 being disposed inwardly relative to the perimeter defined by the lip 212, the hopper 110 can be placed into an interior volume defined by a carrier without the first protrusion 112 and the second protrusion 114 contacting and/or interfering with sidewalls of the carrier. For example, the carrier can define, between two sidewalls of the carrier, an opening to the interior volume. Each of the two sidewalls can have a ridge, and the two ridges can be at least substantially aligned horizontally relative to each other. The hopper 110 can be placed through the opening defined by the carrier, such that a lower surface 214 of the lip 212 can contact and be slid along upper surfaces of the ridges. While the hopper 110 is fully disposed within the interior volume of the carrier, the hopper 110 can be suspended by the ridges contacting the lower surface 214 of the lip 212.

In some implementations, the lip 212 can be dimensioned based on a standard (e.g., a standard associated with the foodservice industry, such as for “hotel” pans configured to be inserted into steam and/or refrigeration tables and/or the like), or any other standardized or suitable size. As a result, the lip 212 and/or hopper 110 can interface with containers, bags, bases, etc., that also conform to the standard and/or common sizing. For example, the lip 212 can be dimensioned based on a ⅓ pan size, having lengthwise edges of approximately 12¾″ and widthwise edges of approximately 6⅞″. Alternatively, the lip 212 can be dimensioned based on a full-size pan (having lengthwise and widthwise edges of approximately 20¾″ and approximately 12¾″, respectively), half pan size (having lengthwise and widthwise edges of approximately 12¾″ and 10⅜″, respectively), etc. The hopper 110 can also be dimensioned to have a depth associated with the standard and/or common in the food industry. For example, the distance from the lip 212 to the support surface can be approximately any of 4″, 6″, 8″, etc.

The openings defined by the first protrusion 112 and the second protrusion 114, respectively, can be covered (e.g., sealed watertight and/or airtight) with caps 242 and 244 that can be releasably coupled to the first protrusion 112 and the second protrusion 114, respectively. In some implementations, the caps 242 and 244 can have equivalent or similar dimensions. For example, the caps 242 and/or 244 can each be configured to be releasably coupled over an end portion of the first and/or second protrusion 114, proximal to the second edge defining the circular opening. While the caps 242 and 244 are releasably coupled to the first protrusion 112 and/or the second protrusion 114, the hopper 110 (including the coupled caps 242 and 244) can be configured to clear the sidewalls of a carrier, such that the hopper 110 can be fully disposed (e.g., enclosed) within the volume of the carrier while being suspended from the carrier ridges, as described above.

The opening defined by the lip 212 can also be covered (e.g., sealed watertight and/or airtight) with a lid 246 that can be releasably coupled to an upper surface 216 of the lip 212. The upper surface 216 can be substantially opposite the lower surface 214 of the lip 212. While the lid 246 is releasably coupled to the upper surface 216 of the hopper 110, the hopper 110 (including the lid 246) can be configured to clear the carrier and be fully disposed (e.g., enclosed) within the interior volume of the carrier. For example, the carrier can have at each of two opposing inner sidewalls an upper ridge and a lower ridge. The lower surface 214 of the lip 212 can rest on an upper surface of the lower ridge while the lip 212 and a portion of the lid 246 are disposed between the upper surface of the lower ridge and a lower surface of the upper ridge. In some instances, the carrier can include a plurality of vertically arranged pairs of ridges, where each ridge from each pair can be disposed horizontally from each other on opposite interior sidewalls. The vertically arranged pairs of ridges can be configured such that a plurality of hoppers can be disposed within the carrier. For example, each hopper 110 from the plurality of hoppers can be arranged vertically (e.g., in a stacked formation) relative to remaining hoppers from the plurality of hoppers.

The carrier can include a door and/or similar covering, configured to cover and/or seal the opening of the carrier while the hopper 110 (and, optionally, the cap(s) and/or lid 246) are disposed within the interior volume of the carrier. The carrier can be configured to insulate the enclosed interior volume from external (e.g., ambient) temperatures, such that the food material disposed within the hopper 110 can be kept fresh and/or prevented from spoiling for a period of time (e.g., 4 hours, less than 4 hours, or more than 4 hours) while the hopper 110 is enclosed within the carrier. While the hopper 110 is enclosed within the carrier, the carrier can be transported from a first location to a second location different from the first location. The first location can be associated with, for example, a preparation facility (e.g., a central kitchen), where food material can be prepared (e.g., washed, sliced, cooked, seasoned, etc.) and/or placed within the interior volume of the hopper 110. The second location be associated with an endpoint (e.g., a restaurant, café, service location, and/or the like).

At the first location, the hopper 110 can be filled with prepared food material via the upper opening 217 while the caps cover the respective openings defined by the first protrusion 112 and the second protrusion 114 and/or while the auger is disposed within the interior volume of the hopper 110. The upper opening 217 can then be covered by the lid 246, and the sealed and/or covered hopper 110 can be placed within the carrier. The carrier can then be transported (e.g., via truck and/or the like) to the second location. In some instances, a first location can be associated with a plurality of second locations. For example, one preparation facility can serve a plurality of endpoints. Upon delivery to a second location, the hopper 110 can remain in the carrier until the food material is to be dispensed, such that food material can remain fresh and/or be prevented from spoiling.

In some implementations, the hopper 110 can be marked (e.g., with a sticker and/or the like) to indicate a time associated with the freshness of the food material disposed within the hopper 110. For example, the time can be associated with an expiration date of the food material, a batch date (e.g., a time associated with the preparation and/or placing of the food material within the interior volume of the hopper 110), and/or the like. The hopper 110 can be marked at the first location such that the food material can be dispensed and/or consumed at and/or near the second location before the food material spoils. Alternatively, the food material can be disposed of (e.g., by dumping the contents via the upper opening 217) if the time marked on the hopper 110 has elapsed without the food material being dispensed from the hopper 110.

The auger 120 being disposed within the hopper 110 (1) before the hopper 110 is filled with food material, (2) before the hopper 110 is coupled to the base 130, and/or (3) after the hopper 110 is decoupled from the base 130 can be preferable to some known designs in which, for example, the hopper is filled with food being placed on the base. For example, as described herein, the auger 120 can be selected, based on the food material to be dispensed from the hopper 110, from a plurality of augers that each have a different characteristic(s). Thus, the auger 120 disposed within the hopper 110 can be matched to the type of food material disposed within the hopper 110. Additionally, the auger 120 being disposed within the hopper 110 can prevent the auger 120 from being contaminated with food material different from that which is disposed within the hopper 110. Moreover, the auger 120 can be cleaned contemporaneously with the hopper 110 after the hopper 110 has been removed from the base 130, and/or contamination and/or cleaning of the base 130 can be reduced.

Once the food material has been removed from the interior volume of the hopper 110 (e.g., after the food material has been dispensed and/or disposed of), the hopper 110 (and/or the cap(s) and/or lid 246) can be washed and/or reused. For example, hopper 110 can be washed at the second location and transported back to the first location to be refilled with food material. Alternatively or in addition, the hopper 110 can be transported back to and washed at the first location.

FIGS. 3A-3B depict, respectively, a perspective view and a perspective cutaway view, of a base 130. The hopper 110 can be releasably coupled to the base 130 prior to dispensing food material within the hopper 110. The base 130 can include a motor 132, an output shaft 134 operably coupled to the motor 132 (e.g., via a belt), a base support surface 301 on which the hopper 110 can rest, a load cell 138, and a weighing surface 136 on which the food vessel 140 (e.g., a disposable bowl, a reusable bowl, and/or the like) can rest. In some implementations, the base 130 can include a speed reducer configured to increase torque output. For example, the speed reducer can be disposed between the motor 132 and the output shaft 134, such that the torque applied to the output shaft 134 and the coupled motor drive interface 222 can be increased (as compared to the torque generated directly from the motor 132 without the speed reducer). To load the hopper 110 onto the base 130, the hopper 110 can be retrieved from the carrier, a refrigeration unit, a storage shelf, and/or the like, and the stands 206 and 208 of the hopper 110 can be placed on the base support surface 301. In some instances, the openings 213 and 215 can be uncovered by removing the caps 242 and 244, such that the auger 120 can be coupled to the output shaft 134, as described herein. In some implementations, vertical extensions (e.g., guardrails) can be disposed at one or more edges of the base support surface and can be configured to prevent translational motion of the hopper 110 while the hopper 110 rests on the base support surface 301. For example, a side guardrail (e.g., the side guardrail 303) can be disposed at each of two lengthwise sides of the base support surface 301, and a front guardrail 302 can be disposed at a front of the base support surface 301 proximal to the weighing surface 136 and/or distal to the output shaft 134.

The output shaft 134 can include a protrusion 304 that can be dimensioned such that at least a portion of the protrusion 304 can be disposed within a depression 224 defined by the motor drive interface 222 of the auger 120. For example, the depression 224 can include an elongated slot, and the protrusion 304 can be an elongated protrusion (e.g., an at least substantially rectangular prism and/or the like). The protrusion 304 can be configured to be disposed within the depression 224 while the protrusion 304 is in at least one orientation relative to the depression 224. For example, at least a portion of the protrusion 304 can be disposed within the slot while the length of the elongated protrusion is substantially aligned with the length of the elongated depression 224. At least a portion of the protrusion 304 can be disposed within a depth of the depression 224 that is sufficient to prevent the protrusion 304 from slipping out of the depression 224 (e.g., cam-out). In some alternative implementations, although not shown in FIGS. 3A-3B, the output shaft 134 can define a depression (e.g., a depression structurally and/or functionally equivalent to the depression 224), and the motor drive interface 222 can define a protrusion (e.g., a protrusion structurally and/or functionally equivalent to the protrusion 304). Any other suitable coupling geometries are also possible.

A dial 135 can be operatively coupled to the output shaft 134, and a user can manually rotate the dial 135 to cause rotation of the protrusion 304, such that the protrusion 304 can be aligned with the depression 224 prior to insertion of at least a portion of the protrusion 304 into the depression 224. To cause the output shaft 134 to be coupled to the auger 120, the protrusion 304 of the output shaft 134 can first be aligned with the depression 224 defined by the motor drive interface 222. Following alignment, the user can lower, between the two side guardrails and towards the base support surface, a portion of the hopper 110 that is proximal to the second protrusion 114, such that the hopper 110 is in an angled orientation (e.g., where the second protrusion 114 is oriented higher than the first protrusion 112 relative to the base support surface). While the hopper 110 is this angled orientation, the user can move the hopper 110 such that a portion of the protrusion 304 can be at least partially inserted into the depression 224. The portion of the hopper 110 proximal to the first protrusion 112 can remain elevated over the front guardrail 302. The front guardrail 302 can be configured to elastically deform, such that when the user applies a downward force to the hopper 110, the hopper 110 can push the guardrail outward (e.g., in a direction away from the output shaft 134). As a result, the hopper 110 can be disposed within a perimeter partially defined by the side guardrails and the front guardrail 302 while the output shaft 134 is operably coupled to the motor drive interface 222 of the auger 120. As a result of the elastic deformation of the front guardrail 302, the front guardrail 302 can apply a bias force in a direction towards the output shaft 134 while the hopper 110 is operably coupled to the base 130. This bias force can prevent cam-out and/or slip while the protrusion 304 of the output shaft 134 is disposed within the depression 224 of the auger 120.

In some implementations, the output shaft 134 can translate along a length parallel to the output shaft 134 and/or the auger 120. For example, the user can pull the dial 135 in a direction parallel to the length of the auger 120, such that the hopper 110 can be placed on the base support surface without the output shaft 134 interfering with the hopper 110 (e.g., the second protrusion 114 of the hopper 110). After the hopper 110 is placed on the base support surface, the output shaft 134 can be aligned with and/or moved towards the motor drive interface 222 of the auger 120, such that a portion of the protrusion 304 can be inserted into the depression 224. In some implementations, the output shaft 134 can be biased (e.g., spring-loaded) towards the motor drive interface 222 of the auger 120. This bias force can cause the protrusion 304 to be inserted within the depression 224 while the protrusion 304 and depression 224 are aligned (e.g., as a result of the user rotating the dial 135).

After the hopper 110 has been coupled to the base 130 and/or the motor drive interface 222 has been coupled to the output shaft 134, a food vessel can be placed on the weighing surface, which can be coupled to the base 130 and/or communicatively coupled to the motor. The food vessel can be arranged such that at least a portion of the food vessel is disposed below and/or is vertically aligned with the outlet defined by the first protrusion 112. After the food vessel has been placed on the weighing surface, the motor 132 can be configured to transition from a stationary state to an active state, which can cause the motor 132 to apply a torque force to the output shaft 134. The motor 132 can be coupled to the output shaft 134 via a belt, which can be coupled to belt interfaces 306 and 308. The belt interfaces 306 and 308 can be (1) disposed proximal to, respectively, the motor 132 and the output shaft 134 and (2) arranged substantially vertically relative to each other. The torque force can cause the output shaft 134 and the auger 120 to rotate. As the auger 120 rotates, the auger 120 can move food material disposed between the windings towards the outlet defined by the first protrusion 112, causing the food material to exit the hopper 110 via the outlet and drop into the food vessel 140. In some implementations, a guide 150 can be coupled to the first protrusion 112 to direct food from the opening 213 towards the food vessel 140.

In some implementations, the motor 132 can be configured to automatically transition from the stationary state to the active state. For example, the weighing surface 136 can be coupled to a load cell 138 and/or a sensor similarly suited for measuring and/or detecting mass. The food vessel 140 being placed on the weighing surface 136 can cause a normal force to be applied to the load cell 138 below the weighing surface, which can cause the load cell 138 to generate a signal indicating the presence of the food vessel 140 on the weighing surface 136. The signal in turn can cause the motor 132 to transition from the stationary state to the active state.

As food material is dispensed into the food vessel 140 while the motor 132 is in the active state, the load cell 138 can generate a signal at a predefined interval (e.g., 100 milliseconds) that can contemporaneously indicate the mass of food material disposed within the food vessel 140. If the signal indicates that a predefined mass of food material is disposed within the food vessel 140, the signal can cause the motor 132 to transition from the active state to the stationary state, which can cause rotation of the auger 120 to stop. As a result, the dispensing of the food material into the food vessel 140 can be stopped or substantially limited.

Alternatively or in addition, in some implementations, a load cell (e.g., a load cell structurally and/or functionally equivalent to the load cell 138) can be disposed under the base 130 and/or the hopper 110. As a result, the motor 132 and/or the quantity of dispensed food material can be controlled based on a decrease in mass (as determined using the load cell) of the food material within the hopper 110.

In some instances, the food vessel 140 can be at least partially filled with initial food material before food material disposed within the interior of the hopper 110 is dispensed into the food vessel 140. This initial food material can include, for example, an edible base food material, such as lettuce, dressing, salad, rice, lentils, and/or the like. In some implementations, the base 130 can include a processor configured to determine a net weight of the dispensed food material by subtracting (1) a tare weight of the food vessel 140 and the initial food material from (2) a gross weight of the food vessel 140, the initial food material, and the dispensed food material.

An absolute measure, relative measure (e.g., greater than, less than, etc.), absolute orientation (e.g., vertical, horizontal, etc.), relative orientation (e.g., parallel to, perpendicular to, etc.), and/or the like, when followed by the terms “substantially,” “approximately,” and/or the like, can include up to a 20% variation of the respective absolute measure, relative measure, absolute orientation, relative orientation, and/or the like.

While various embodiments have been described above, it should be understood that they have been presented by way of example only, and not limitation. Furthermore, although various embodiments have been described as having particular features and/or combinations of components, other embodiments are possible having a combination of any features and/or components from any of embodiments where appropriate as well as additional features and/or components.

Some embodiments described herein relate to methods and/or processing events, for example, methods of operating the motor 132 and/or determining and/or detecting a mass using the load cell 138. It should be understood that such methods and/or processing events can be computer-implemented. That is, where method or other events are described herein, it should be understood that they may be performed by a compute device having a processor and a memory. For example, some embodiments discussed above relate to a controller communicatively coupled to the motor 132 and/or the load cell 138. Such a controller can be any suitable compute device, including a stand-alone computer, a cloud-based service, and/or completely and/or partially integrated with the motor 132 and/or the load cell 138.

Memory of a compute device is also referred to as a non-transitory computer-readable medium, which can include instructions or computer code for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules, Read-Only Memory (ROM), Random-Access Memory (RAM) and/or the like. One or more processors can be communicatively coupled to the memory and operable to execute the code stored on the non-transitory processor-readable medium. Examples of processors include general purpose processors (e.g., CPUs), Graphical Processing Units, Field Programmable Gate Arrays (FPGAs), Application Specific Integrated Circuits (ASICs), Digital Signal Processor (DSPs), Programmable Logic Devices (PLDs), and the like. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a container including:
a first protrusion defining a first opening,
a second protrusion substantially opposite the first protrusion and defining a second opening, and
a lip circumscribing the container and defining an upper opening of the container;
an auger, a first end portion of the auger disposed within the first protrusion, a second end portion of the auger disposed within the second protrusion;
a first cap configured to be releasably coupled to the first protrusion to cover the first opening;
a second cap configured to be releasably coupled to the second protrusion to cover the second opening; and
a lid configured to be releasably coupled to the lip to cover the upper opening.

2. The apparatus of claim 1, further comprising:
a weighing surface coupled to a load cell; and
a motor communicatively coupled to the load cell and configured to transition from an active state to a stationary state in response to the load cell indicating a threshold force is applied to the weighing surface.

3. The apparatus of claim 2, further comprising:
a receptacle configured to rest on the weighing surface and receive materials dispensed from the container.

4. The apparatus of claim 1, wherein:
the auger is configured to rotate within the first protrusion and the second protrusion;
the first end portion of the auger is configured to expel materials from the container through the first protrusion; and
the second end portion of the auger is configured to be releasably coupled to a motor that is configured to rotate the auger.

5. The apparatus of claim 1, wherein the lip extends proud relative to the first protrusion and the second protrusion.

6. The apparatus of claim 5, wherein:
the first protrusion is disposed at a first sidewall of the container;
the second protrusion is disposed at a second sidewall of the container;
the first sidewall includes a first tapered portion that is disposed between the lip and the first protrusion; and
the second sidewall includes a second tapered portion that is disposed between the lip and the second protrusion.

7. A method, comprising:
filling, at a first location, a first container with food material via an upper opening, the first container including (1) a lip that circumscribes the upper opening, (2) a first protrusion that defines an outlet, (3) a second protrusion that is disposed substantially opposite the first protrusion and that defines an interface opening, and (4) an auger that has a first end portion disposed within the first protrusion and a second end portion disposed within the second protrusion;
releasably coupling a lid to the lip to cover the upper opening;
placing the first container within a volume defined by a second container;
transporting the second container including the first container to a second location different from the first location;
removing the first container from the volume defined by the second container;
removing a first cap from the first protrusion to uncover the outlet;
removing a second cap from the second protrusion to uncover the second end portion of the auger;
releasably coupling the second end portion of the auger to a motor; and
causing the motor to transition from a stationary state to an active state to cause the auger to rotate and the food material to be dispensed via the outlet.

8. The method of claim 7, wherein:
the placing includes sliding, in a first direction, a surface of the lip over a surface of a ridge disposed on the second container to cause the first container to be suspended within the volume defined by the second container; and
the removing the first container includes sliding, in a second direction opposite the first direction, the surface of the lip over the surface of the ridge.

9. The method of claim 7, wherein the auger is a first auger, and the food material is first food material, the method further comprising:
removing, at the second location, a third container from the volume defined by the second container;
uncoupling the first auger from the motor;
releasably coupling to the motor an end portion of a second auger disposed within the third container; and
causing the motor to transition from the stationary state to the active state to cause (1) the second auger to rotate and (2) second food material disposed within the third container to be dispensed via an outlet of the third container.

10. The method of claim 7, wherein the first location is associated with a preparation facility and the second location is associated with a food service endpoint.

11. An apparatus, comprising:
a container including:
a first protrusion defining a first opening, and
a second protrusion substantially opposite the first protrusion and defining a second opening;
an auger configured to rotate within the first protrusion and the second protrusion and to expel materials from the container through the first protrusion;
a motor coupled to the auger via the second protrusion, the motor removably coupled to the auger such that the container and the auger can be collectively removed from the motor.

12. The apparatus of claim 11, further comprising:
a cap configured to be releasably coupled to the first protrusion to cover the first opening.

13. The apparatus of claim 11, further comprising:
a cap configured to be releasably coupled to the second protrusion to cover the second opening.

14. The apparatus of claim 11, further comprising:
a first cap configured to be releasably coupled to the first protrusion to cover the first opening;
a second cap configured to be releasably coupled to the second protrusion to cover the second opening.

15. The apparatus of claim 11, further comprising:
a cap configured to be releasably coupled to the second protrusion to cover the second opening, the cap configured to provide access to a coupling portion of the auger to which the motor couples.

16. The apparatus of claim 11, wherein the container and the auger are removably coupled to the motor such that removing the container from the motor causes the auger to be removed from the motor and remain disposed in the container.

17. The apparatus of claim 11, wherein the container and the auger are configured to be transported together, without the motor.
